(19) United States
(12) Patent Application Publication
(10) Pub. No.: US 2025/0158319 A1
(43) Pub. Date: May 15, 2025

(54) SEALED CONNECTOR

(71) Applicant: IDEAL Industries, Inc., Sycamore, IL (US)

(72) Inventors: Robert W. Sutter, De Kalb, IL (US); Kyle R. Schnake, Woodstock, IL (US); Sushil N. Keswani, Sycamore, IL (US); Alan E. Zantout, Sycamore, IL (US)

(21) Appl. No.: 18/835,588

(22) PCT Filed: Feb. 4, 2022
(86) PCT No.: PCT/US2022/015216

§ 371 Date: Aug. 2, 2024

(51) Int. Cl. H01R 13/52; H01R 43/00

(52) U.S. Cl. CPC H01R 13/5205; H01R 43/005

(57) ABSTRACT

A sealed connector is provided for electrically connecting a plurality of wires The sealed connector includes a housing defining a cavity adapted for receiving a sealant therein, A plunger is slidably receivable in the cavity of the housing. The plunger defines a passageway through the plunger for allowing the plurality of wires to pass therethrough. A connector Is positionable at an end of the plunger and is configured to electrically connect the plurality of wires. A compression plate extends from an inner surface of the plunger into a passageway through the plunger. The compression plate includes a lower surface configured to urge sealant provided in the cavity toward the connector as the plunger is inserted into the plunger cavity.

### FIELD OF THE INVENTION

The present invention relates generally to electrical connectors, and in particular, to a sealed connector for electrically connecting a plurality of wires.

### BACKGROUND AND SUMMARY OF THE INVENTION

As is known, there are a variety of types of electrical connectors available for electrically coupling a two or more electrical wires together. By way of example, electrical wires may be electrically coupled by simply soldering or twisting the ends of the electrical wires together. Alternatively, twist on connectors are commonly used for twisting wire ends together. Similarly, wire connectors which mechanically interconnect the ends of two or more electrical wires together are also available. These types of wire connectors may utilize an electrically conductive material to facilitate current flow between the wires.

It can be appreciated that in some applications, it is desirable to isolate an electrical connection between two or more wires from the external environment in order to avoid corrosion of the metal conductive components and/or to avoid unintentional grounding or shorting of an electric circuit. In circumstances wherein an electrical connection is made outdoors, below ground or in underwater applications, the electrical connection and the wire connector of choice used to interconnect the two or more wires may be exposed to precipitation, atmospheric humidity, corrosive soil conditions, ground water and the like. It can be appreciated that exposure to these types of environmental conditions can cause the electrical connection and/or the wire connector to fail, thereby resulting in the unintentional grounding or shorting of the electrical connection of a corresponding electric circuit.

Heretofore, various types of sealing arrangements have been developed to isolate an electrical connection from the external environment. For example, many electrical connections are wrapped in electrical tape or otherwise enclosed by a housing. While functional for their intended purpose, these prior sealing arrangements have certain limitations. While electrical tape has a certain level of weather and water-resistance, the adhesive properties of the tape tend to fail when the electrical tape is exposed to more than minimal amounts of liquid, and hence, are not used in situations where larger amounts of liquid are involved. Similarly, a housing which encloses the electrical connection may be prone to leakage. As such, when exposed to large amounts of liquid, the liquid may seep into housing and cause the unintentional grounding or shorting of the electrical connection contained therein.

In order to overcome the limitations associated with the use of housings, electrical connectors have been developed that utilize a sealing agent to encompass the electrical connection within the housing to isolate the electrical connection from the external environment. Caviar, U.S. Pat. No. 4,491,686 discloses an electrical connector which utilizes a potting compound within a cavity formed by a hollow core received within a hollow casing. The ends of a pair of wires can be twisted together for conduction and then potted in the hollow core with an insulating sealant, such as silicon. Similarly, King, Jr., U.S. Pat. No. 5,151,239 discloses a solderless twist on wire connector wherein a user twists the wire connector onto two or more wires to simultaneously compress the junction ends of electrical wires into low resistance electrical contact while encapsulating the junction ends of the electrical wires in a solderless substance.

As described, the noted prior art structures contemplate the insertion of the junction ends of the electrical wires into an insulating sealant within a housing. It can be appreciated that in such an arrangement, the insulating sealant may not completely encompass and surrounded the junction ends of the electrical wires due to the flow of the sealant in response to the insertion of the junction ends of the electrical wires therein. Further, in the prior art structures, the insulating sealant may be exposed to the environment outside of the housing. As such, exposure of the insulating sealant to the types of environmental conditions outside of the housing can cause the insulating sealant to fail, thereby exposing the electrical connection and/or the wire connector to the environment outside of the housing. As noted above, exposure of the electrical connection and/or the wire connector to the environment outside of the housing may result in the unintentional grounding or shorting of the electrical connection of a corresponding electric circuit. In view of the foregoing, it can be understood that a need exists in the art to provide a sealed connector for electrically connecting a plurality of wires in a sealed environment.

In accordance with the present invention, a sealed connector for electrically connecting a plurality of wires is provided. The sealed connector includes a tubular housing having a closed end, an open end, and an inner surface defining a plunger cavity adapted for receiving a sealant therein. A plunger has first and second ends and a sidewall configured to allow the plurality of wires to be routed therepast. The plunger is slidably receivable in the plunger cavity of the housing. A connector is configured to electrically connect the plurality of wires. The connector is positionable at the second end of the plunger. The plunger urges the connector toward the closed end of the housing as the plunger is inserted into the plunger cavity.

It is contemplated for the plunger to be generally tubular and have first and second open ends. The sidewall includes a slot therethrough and defines a passageway through the plunger for allowing the plurality of wires to pass therethrough. A compression plate extends from sidewall of the plunger. The compression plate includes a lower surface configured to engage and urge the sealant in the plunger cavity toward the closed end of the housing as the plunger is inserted into the plunger cavity. The compression plate includes at least one aperture for allowing the plurality of wires to pass therethrough. The at least one aperture is defined by an inner edge of the compression plate. The inner edge of the compression plate includes a plurality of concave portions. Each of the plurality of concave portions define a guide configured to guide a corresponding one of the plurality of wires through the aperture in the compression plate.

A lid is positionable on the open end of the housing. The lid is moveable from an open position allowing for the plunger to be inserted into and removed from the plunger cavity in the housing and a closed position wherein the lid at least partially isolates the plunger received in the plunger cavity from an environment external to the housing. At least one of the housing and the lid includes a recess formed therein. The recess allows at least one of the plurality of wires to pass into the plunger cavity with the lid in the closed position. The lid includes an inner surface having a strain relief projection projecting therefrom. The strain relief projection is engagable with at least one of the plurality of wires passing into the plunger cavity with the lid in the closed position.

The housing further includes a shoulder projecting from the inner surface of the housing adjacent the open end thereof. The sidewall of the plunger has an outer surface and the plunger includes a lip projecting from the outer surface of the plunger adjacent the first end thereof. The lip is engageable with the shoulder of the housing with the plunger received in the plunger cavity of the housing. The second end of the plunger is defined by a lower edge. The lower edge has a configuration adapted to form a mating relationship with the connector.

In accordance with a further aspect of the present invention, a sealed connector for electrically connecting a plurality of wires is provided. The sealed connector includes a housing having an inner surface defining a cavity adapted for receiving a sealant therein. A plunger has first and second ends and a surface configured to allow the plurality of wires to pass therethrough. The plunger is slidably receivable in the cavity of the housing. A connector is configured to electrically connect the plurality of wires. The connector is positionable at the second end of the plunger. The plunger urges the connector into the plunger cavity as the plunger is inserted into the plunger cavity.

The plunger may be generally tubular and include a sidewall. The sidewall includes a slot therethrough. The first and second ends of the plunger are open. The surface of the plunger is an inner surface of the sidewall. The inner surface defines a passageway through the plunger for allowing the plurality of wires to pass therethrough.

The cavity in the housing has a closed end and the sealed connector may further include a compression plate extending from the surface of the plunger. The compression plate includes a lower surface configured to engage and urge the sealant in the cavity toward the closed end of the housing as the plunger is inserted into the cavity. The compression plate may include at least one aperture for allowing the plurality of wires to pass therethrough. The at least one aperture is defined by an inner edge of the compression plate. The inner edge of the compression plate includes a plurality of concave portions. Each of the plurality of concave portions define a guide configured to guide a corresponding one of the plurality of wires through the aperture in the compression plate.

A lid is positionable on the housing. The lid is moveable from an open position allowing for the plunger to be insert into and removed from the cavity in the housing and a closed position. The lid includes an inner surface having a strain relief projection projecting therefrom. The strain relief projection is engagable with at least one of the plurality of wires passing into the cavity with the lid in the closed position. The second end of the plunger is defined by a lower edge. The lower edge has a configuration adapted to form a mating relationship with the connector.

In accordance with a still further aspect of the present invention, a method is provided for electrically connecting terminal ends of a plurality of wires. The method includes the steps of depositing a sealant in a plunger cavity of a housing and positioning the terminal ends of the plurality of wires at an end of a plunger. The terminal ends of the plurality of wires are electrically connected and the electrically connected terminal ends of the plurality of wires are inserted into the sealant in the plunger cavity in the housing with the plunger.

The method may include the additional step of urging the sealant in the plunger cavity toward the electrically connected terminal ends of the plurality of wires such that sealant surrounds and environmentally isolates the electrically connected terminal ends of the plurality of wires from an environment outside the housing. The step of urging the sealant in the plunger cavity toward the electrically connected terminal ends of the plurality of wires may include the step of providing a compression plate which extends from a surface of the plunger. The compression plate including a lower surface configured to engage the sealant provided in the plunger cavity toward the electrically connected terminal ends of the plurality of wires as the plunger is inserted into the plunger cavity.

The plurality of wires may be guided through the compression plate. More specifically, the electrically connected terminal ends of the plurality of wires are guided by an inner edge of the compression plate. The inner edge of the compression plate defines a plurality of concave portions. Each of the plurality of concave portions of the inner edge of the compression plate is adapted for receiving a corresponding one of the plurality of wires therepast. It is contemplated for the terminal ends of the plurality of wires to be electrically connected by a connector and for the plunger to include a lower edge. The lower edge of the plunger is adapted to form a mating relationship with the connector.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a sealed connector in accordance with the present invention, with a lid in a closed position;

FIG. 2 is an isometric view of a sealed connector of the present invention, similar to FIG. 1, with the lid in an open position;

FIG. 3 is an isometric view showing connection of a plurality of wires to a connector of the sealed connector of the present invention;

FIG. 4 is an isometric view of a plunger and connector combination for the sealed connector of the present invention;

FIG. 5 is an isometric view showing insertion of the plunger and connector combination into a housing of the sealed connector of the present invention;

FIG. 6 is an isometric view, similar to FIG. 2, showing the path of the wires within into the sealed connector of the present invention;

FIG. 7 is a cross-sectional view of the sealed connector of the present invention taken along line 7-7 of FIG. 2;

FIG. 8 is a cross-sectional view of the sealed connector of the present invention taken along line 8-8 of FIG. 2;

FIG. 9 is an isometric view of a plunger for the sealed connector of the present invention;

FIG. 10 is a cross-sectional view of the plunger for the sealed connector of the present invention taken along line 10-10 of FIG. 9;

FIG. 11 is an isometric view of a housing for the sealed connector of the present invention; and

FIG. 12 is a cross-sectional view of the housing for the sealed connector of the present invention taken along line 12-12 of FIG. 11.

### DETAILED DESCRIPTION OF THE DRAWINGS

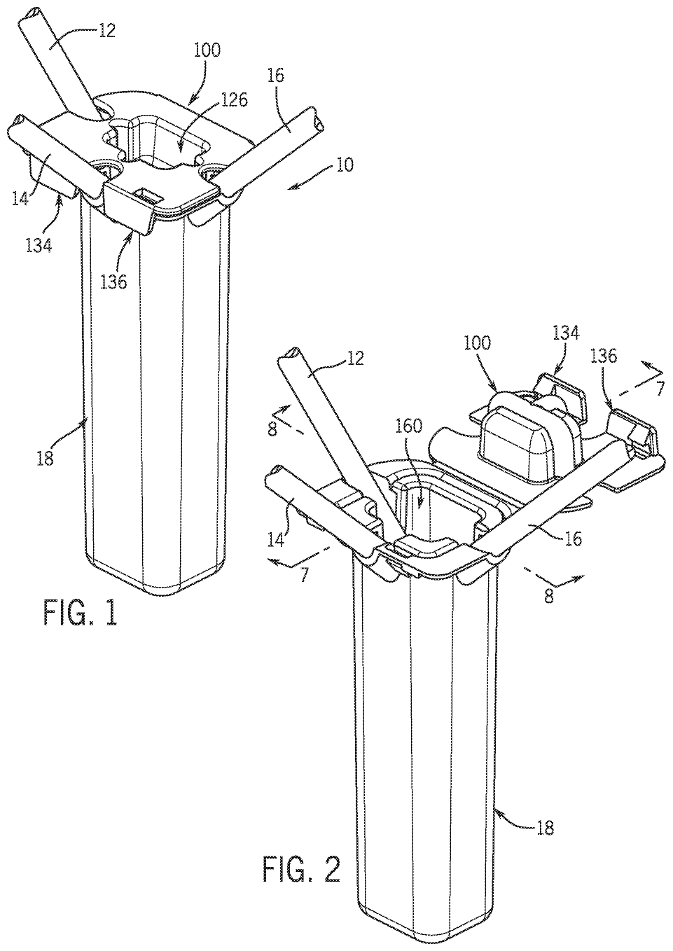

Referring to FIGS. 1-2, a sealed connector in accordance with the present invention is generally designated by the reference numeral 10. It is intended for sealed connector 10 to electrically connect a plurality of wires and electrically isolate the electrically connected plurality of wire from the surrounding environment. By way of example, the sealed connector 10 is hereinafter described as electrically connecting first, second and third wires 12, 14, and 16, respectively. However, it can be appreciated that sealed connector 10 may be used to interconnect a different number of wires without deviating from the scope of the present invention. Further, it is contemplated for sealed connector 10 to be used to electrically connect various types of electrical equipment, e.g. irrigation equipment, where it is desired for an electrical connection to be electrically isolated from the surrounding environment, such as outdoors, adjacent water, underground, or the like.

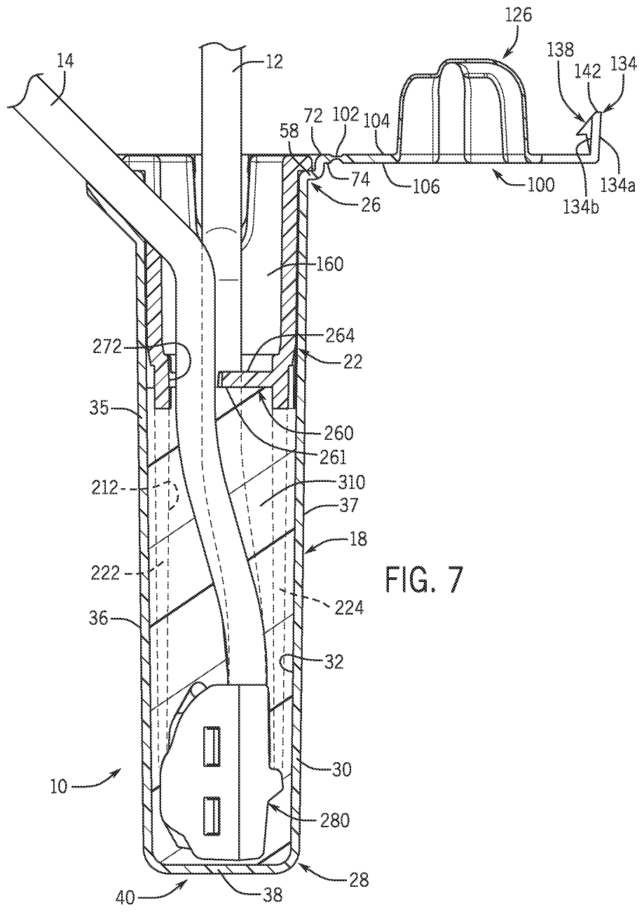

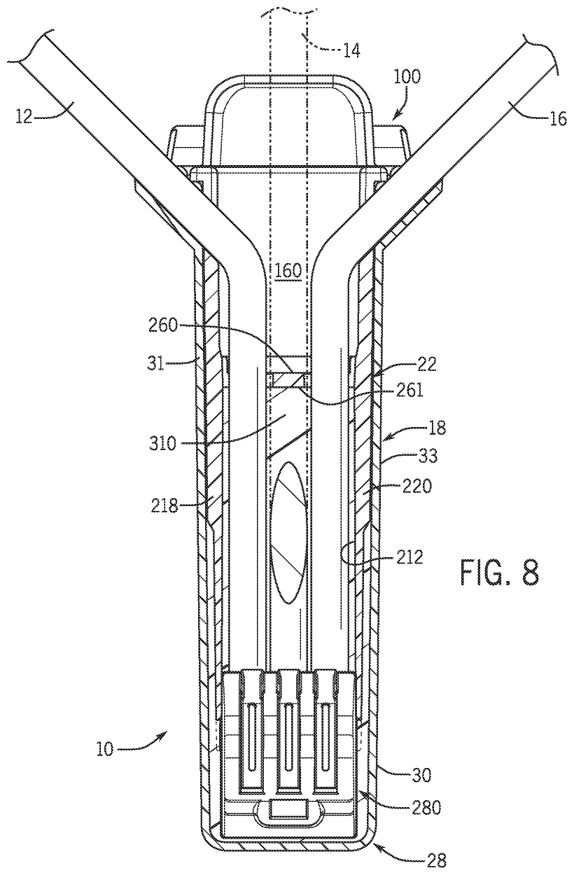

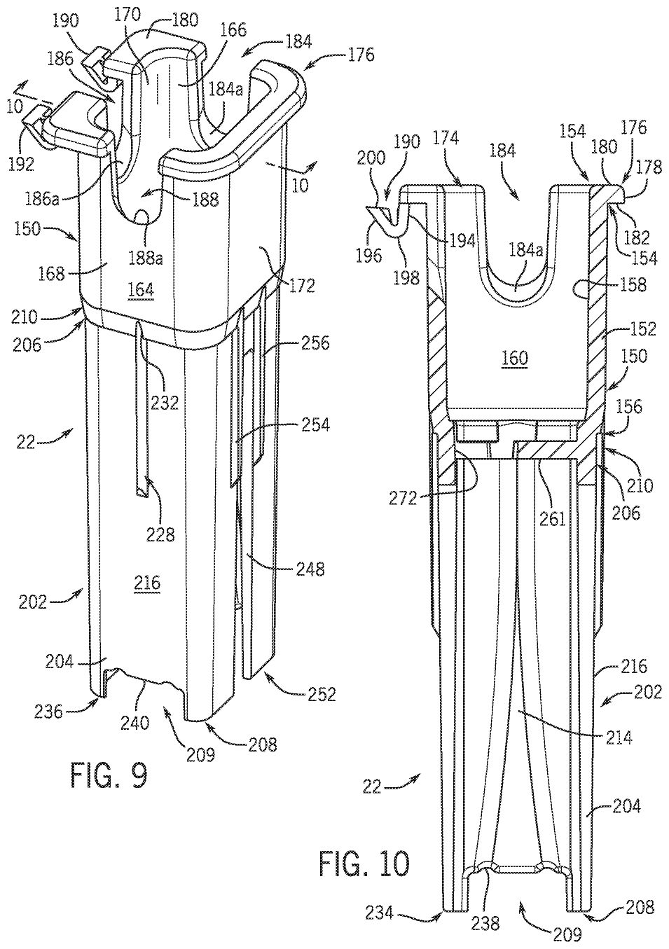

As best seen in FIGS. 7-8 and 11-12, sealed connector 10 includes a tube or housing 18 defining plunger cavity 20 which is adapted for slidably receiving plunger 22, FIGS. 8-9, therein. More specifically, housing 18 extends along an axis and is partially defined by sidewall 30. Sidewall 30 has first and second ends 26 and 28, respectively, and includes an inner surface 32 partially defining plunger cavity 20 and an outer surface 36. Sidewall 30 is defined by first and second generally parallel side portions 31 and 33, respectively, interconnected by first and second end portions 35 and 37, respectively, such that sidewall 30 has a generally rectangular configuration. As such, in the depicted embodiment, plunger cavity 20 has a generally rectangular configuration. However, it can be understood that plunger cavity 20 may have other configurations without deviating from the scope of the present invention.

Lower wall 38 closes second end 28 of sidewall 30 and defines closed end 40 of housing 18. Lower wall 38 includes an inner surface 42 directed to and in communication with plunger cavity 20. Outer periphery 44 of inner surface 42 of lower wall 38 intersects and is integral with lower edge 46 of inner surface 32 of sidewall 30. Similarly, outer periphery 48 of outer surface 50 of lower wall 38 intersects and is integral with lower edge 52 of outer surface 36 of sidewall 30.

First end 26 of sidewall 30 defines an opening 54 in housing 18 which communicates with plunger cavity 20. Shoulder 56 is provided in sidewall 30 adjacent to first end 26. Shoulder 56 is defined by horizontal wall 58 having an upper surface, projecting radially outward from sidewall 30 and terminating at a radially outer end 60. Vertical wall 64 projects vertically from radially outer end 60 of horizontal wall 58 and terminates at upper end 66.

Flange 68 projects radially outward from upper end 66 of vertical wall 64 and terminates at radially outer edge 70. Flange 68 is defined by a generally flat, upper surface 72 and a generally flat, lower surface 74. Recesses 76, 78 and 80 are provided in flange 68 and are spaced about sidewall 30. More specifically, recess 76 is defined by arcuate surface 82 having a generally concave configuration. Arcuate surface 82 extends between a first edge 84 lying in a plane and intersecting flange 68, vertical wall 64 of shoulder 56, horizontal wall 58 of shoulder 56, and inner surface 32 of sidewall 30 along first side portion 31 thereof and a second edge 86, lying in a plane generally parallel to and spaced from the plane in which first edge 84 lies. Similar to first edge 84, second edge 86 of arcuate surface 82 intersects flange 68, vertical wall 64 of shoulder 56, horizontal wall 58 of shoulder 56, and inner surface 32 of sidewall 30 along first side portion 31 thereof.

Recess 78 is defined by arcuate surface 88 having a generally concave configuration. Arcuate surface 88 extends between a first edge 90 lying in a plane and intersecting flange 68, vertical wall 64 of shoulder 56, horizontal wall 58 of shoulder 56, and inner surface 32 of sidewall 30 along first end portion 35 thereof and a second edge 92, lying in a plane generally parallel to and spaced from the plane in which first edge 90 lies. Similar to first edge 90, second edge 92 of arcuate surface 88 intersects flange 68, vertical wall 64 of shoulder 56, horizontal wall 58 of shoulder 56, and inner surface 32 of sidewall 30 along first end portion 35 thereof. Apertures 91 and 93 are provided on opposite sides of recess 78 and extend through flange 68 and shoulder 56, for reasons hereinafter described.

Recess 80 is defined by arcuate surface 94 having a generally concave configuration. Arcuate surface 94 extends between a first edge 96 lying in a plane and intersecting flange 68, vertical wall 64 of shoulder 56, horizontal wall 58 of shoulder 56, and inner surface 32 of sidewall 30 along second side portion 33 thereof and a second edge 98, lying in a plane generally parallel to and spaced from the plane in which first edge 96 lies. Similar to first edge 96, second edge 98 of arcuate surface 94 intersects flange 68, vertical wall 64 of shoulder 56, horizontal wall 58 of shoulder 56, and inner surface 32 of sidewall 30 along second side portion 33 thereof.

Lid 100 is pivotably connected to flange 68 at a location opposite recess 78 and adjacent to second end portion 37 of sidewall 30. It the depicted embodiment, lid 100 is pivotably connected to flange 68 by living hinge 102, as hereinafter described. However, it can be appreciated that other mechanisms may be used to pivotably connect lid 100 to flange 68 without deviating from the scope of the present invention. Lid 100 is defined a generally flat inner surface 104 and a generally flat outer surface 106 interconnected by outer peripheral edge 108.

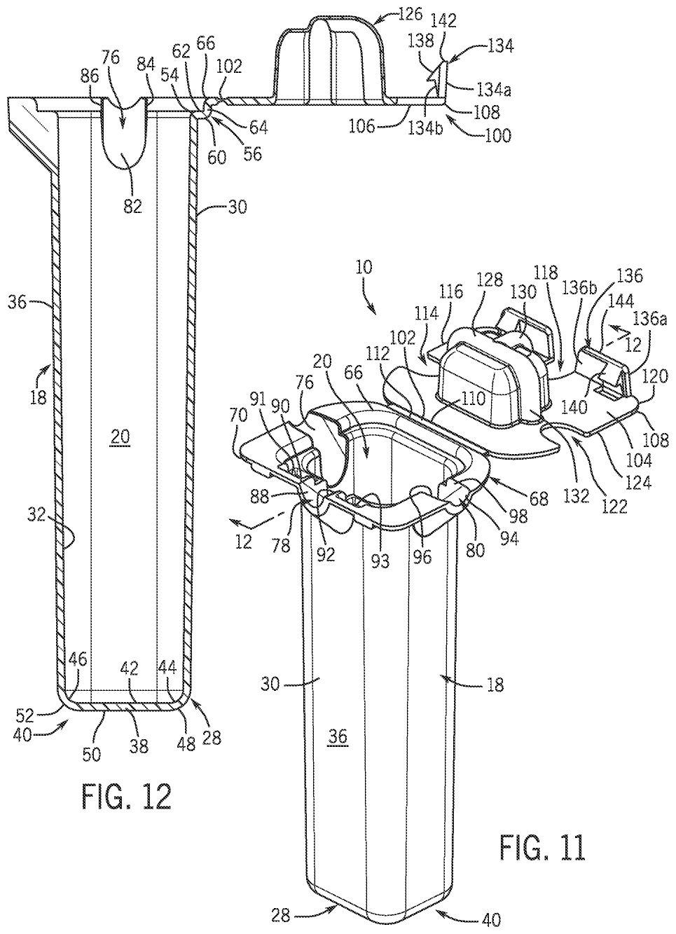

Lid 100 includes first recess 114 in first portion 116 of outer peripheral edge 108, second recess 118 in second portion 120 of outer peripheral edge 108 and third recess 122 in third portion 124 of outer peripheral edge 108. First and third portions 116 and 124, respectively, of outer peripheral edge 108 are generally parallel and spaced from each other by second and fourth portions 120 and 110, respectively, of outer peripheral edge 108. Fourth portion 110 of outer peripheral edge 108 is generally parallel to second portion 124 of outer peripheral edge 108 and is pivotably connected to first portion 112 of outer edge 70 of flange 68 by living hinge 102, such that lid 100 is pivotable between a first open position, FIGS. 2 and 11, allowing access to plunger cavity 20 through opening 54 in housing 18 and a second closed position, FIGS. 1 and 12. With lid 100 in the closed position, it is contemplated for first recess 114 in lid 100 to overlap and provide access to recess 76 in flange 68, second recess 118 in lid 100 to overlap and provide access to recess 78 in flange 68; and third recess 122 to overlap and provide access to recess 80 in flange 68.

Lid 100 further includes strain relief dome 126 projecting from and centrally disposed on inner surface 104 thereof. Strain relief dome 126 includes first, second and third relief portions 128, 130 and 132, respectively, which are positioned adjacent corresponding recesses 76, 78 and 80, respectively, in sidewall 30 of housing 18, for reasons hereinafter described. First and second flexible latches 134 and 136, respectively, project from inner surface 104 of lid 100 on opposite sides of second recess 118 in a direction generally perpendicular to inner surface 104 and terminate at terminal edges 142 and 144, respectively. Each of the first and second flexible latches 134 and 136, respectively, includes a corresponding outer surface 134a and 136a, respectively, which lies in a common plane with third portion 124 of outer peripheral edge 108 and a corresponding inner surface 134b and 136b, respectively. Tangs 138 and 140 project from corresponding inner surfaces 134b and 136b, respectively, at a location adjacent from corresponding terminal edges 142 and 144, respectively, and spaced from inner surface 104 of lid 100. It is intended for first and second flexible latches 134 and 136, respectively, to retain lid 100 in the closed position, as hereinafter described.

Referring to FIGS. 7-10, plunger 22 extends along an axis and includes upper body portion 150 defined by sidewall 152. Sidewall 152 has first and second ends 154 and 156, respectively, and includes an inner surface 158 defining upper wire passageway 160 and an outer surface 164. Sidewall 152 is defined by first and second generally parallel side portions 166 and 168, respectively, interconnected by first and second end portions 170 and 172, respectively, such that sidewall 152 has a generally rectangular configuration. It is intended for sidewall 152 to be configured such that outer surface 164 of sidewall 152 forms a slideable interface with inner surface 32 of sidewall 30 of housing 18.

First end 154 of sidewall 152 of plunger 22 defines opening 174 which communicates with upper wire passageway 160. Flange 176 projects radially outward from first end 154 of sidewall 152 of plunger 22 and terminates at radially outer edge 178. Flange 176 is defined by a generally flat, upper surface 180 and a generally flat, lower surface 182. Recess 184 extends through flange 176 and into first side portion 166 of sidewall 152. Recess 186 extends through flange 176 and into first end portion 170 of sidewall 152. Recess 188 extends through flange 176 and into second side portion 168 of sidewall 152. Each recess 184, 186 and 188 is defined by a corresponding arcuate edge 184a, 186a, and 188a, respectively, having a generally concave configuration. First and second v-shaped latches 190 and 192, respectively, depend from radially outer edge 178 of flange 176 on opposite sides of recess 186. More specifically, each latch 190 and 192 includes a first leg 194 depending from flange 176, extending away from first end portion 170 of sidewall 152 and terminating at vertex 198 and a second leg 196 extending from vertex 198 and terminating at terminal edge 200. Terminal edge 200 of second leg 196 is spaced from first leg 194 by a distance. It is contemplated for first and second legs 194 and 196, respectively, of each latch 190 and 192 to be compressible toward each other, for reasons hereinafter described.

Plunger 22 further includes lower body portion 202 defined by sidewall 204 having first and second ends 206 and 208, respectively. First end 206 of sidewall 204 of lower body portion 202 is joined to second end 156 of sidewall 152 of upper body portion 150 at intersection 210 such that lower body portion 202 depends from upper body portion 150. Sidewall 204 of lower body portion 202 includes inner surface 212 defining lower wire passageway 214 and an outer surface 216. Sidewall 204 is defined by first and second generally parallel side portions 218 and 220, respectively, interconnected by first and second end portions 222 and 224, respectively, such that sidewall 204 has a generally rectangular configuration. It is intended for the outer dimensions of sidewall 204 to be less than the outer dimensions of sidewall 152 such that outer surface 216 of sidewall 204 is spaced from inner surface 32 of sidewall 30 of housing 18 with plunger 22 received in plunger cavity 20, as hereinafter described. Second end 208 of sidewall 204 defines opening 209 in communication with lower wire passageway 214.

First and second side portions 218 and 220, respectively, of sidewall 204 include corresponding ribs 228 extending along outer surface 216 thereof. Ribs 228 have first ends 232 intersecting intersection 210 and extend longitudinally along outer surface 216 toward second end 208 of sidewall 204. It is intended for ribs 228 to add strength and stability to lower body portion 202 of sidewall 204 when plunger 22 is inserted into plunger cavity 20, as hereinafter described. Alternatively, or in addition to, slots (not shown) may be provided in first and second side portions 218 and 220, respectively, of sidewall 204 to facilitate the flow of sealant 310 around connector 280, for reasons hereinafter described.

Terminal ends 234 and 236 of first and second side portions 218 and 220, respectively, of sidewall 204 include concave recesses 238 and 240, respectively, which correspond in size and shape to upper wall 308 of housing 282 of connector 280, for reasons hereinafter described. In addition, first and second end portions 222 and 224, respectively, of sidewall 204 include corresponding slots 246 and 248, respectively, extending through. Slots 246 and 248 extend from terminal ends 250 and 252, respectively, of first and second end portions 222 and 224, respectively, of sidewall 204 toward intersection 210. It is contemplated for slots 246 and 248 to extend from terminal ends 250 and 252, respectively, of first and second end portions 222 and 224, respectively, of sidewall 204 to flange 176 as being within the scope of the present invention. Ribs 254 and 256 may be provided along outer surface 216 of sidewall 204 on opposite sides of slots 246 and 248. Ribs 254 and 256 extend longitudinally from intersection 210 along outer surface 216 of sidewall 204 to add strength and stability to lower body portion 202 of sidewall 204 when plunger 22 is inserted into plunger cavity 20, as hereinafter described. In addition, ribs 228, 254 and 256 along outer surface 216 of sidewall 204 space outer surface 216 of sidewall 204 from inner surface 32 of sidewall 30 of housing 18 with plunger 22 received in plunger cavity 20, as hereinafter described.

Referring to FIGS. 6-10, plunger 22 further includes compression plate 260 which projects radially inwardly inner surface 212 of sidewall 204 at a location spaced from intersection 210 so as to separate upper and lower wire passageways 160 and 214, respectively. Compression plate 260 includes lower surface 261 directed at lower wire passageway 214, upper surface 264 directed at upper wire passageway 160 and aperture 262 therethrough to allow for first, second and third wires 12, 14, and 16, respectively, to pass between upper and lower wire passageways 160 and 214, respectively. Aperture 262 is defined by inner edge 266 of compression plate 260. Inner edge 260 includes first, second and third concave recesses 270, 272 and 274 therein for guiding first, second and third wires 12, 14, and 16, respectively, from upper wire passageway 160 to lower wire passageway 214 and aligning first, second and third wires 12, 14, and 16, respectively, with corresponding recesses 184, 186 and 188, respectively, in sidewall 204, for reasons hereinafter described.

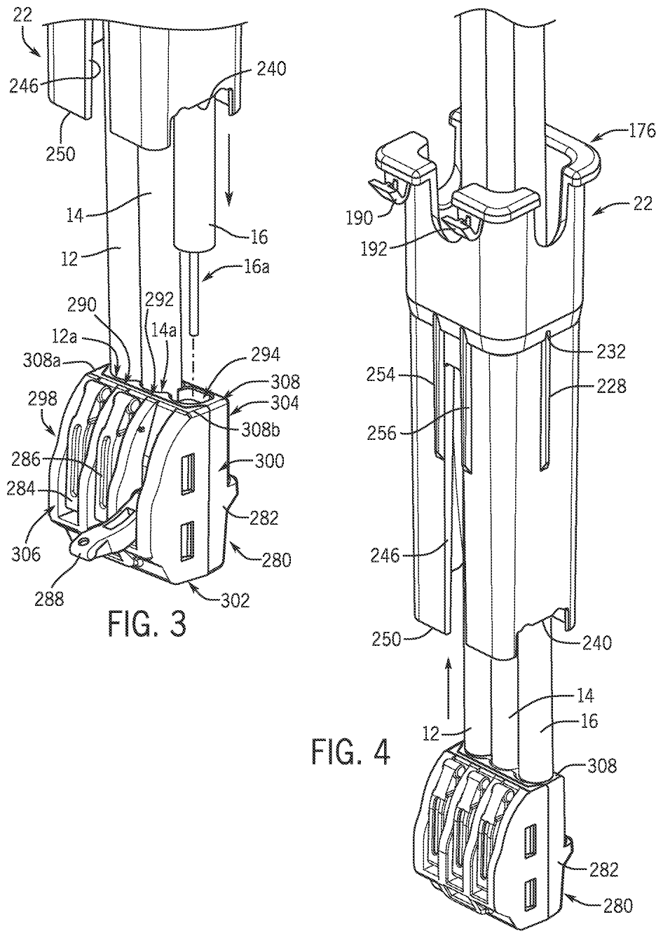

In order to electrically couple first, second and third wires 12, 14, and 16, respectively, connector 280 is provided, FIGS. 3-4. In the depicted embodiment, connector 280 takes the form of a lever connector. However, other types of electrical connectors, such a splicing connector or the like, may by used without deviating from the scope of the present invention. As is conventional, lever connector 280 includes insulated housing 282 having internal spring terminal connections (not shown) into which stripped terminal ends 12a, 14a and 16a of first, second and third wires 12, 14, and 16, respectively, may be received. More specifically, housing 282 includes first and second sides 298 and 300, respectively, spaced by bottom wall 302, rear wall 304, front wall 306 and upper wall 308. Upper wall 308 includes first, second and third passages 290, 292 and 294, respectively, in housing 282 which communicate with corresponding internal spring terminal connections (not shown). It is contemplated for portions 308a and 308b of upper wall 308 adjacent to first and second sides 298 and 300, respectively, to be configured to form a mating relationship with recesses 238 and 240, respectively, in terminal ends 234 and 236 of corresponding first and second side portions 218 and 220, respectively, of sidewall 204, for reasons hereinafter described.

Front wall 306 of housing 282 includes first, second and third pivotable actuators 284, 286 and 288, respectively, operatively connected to corresponding internal spring terminal connections. First, second and third pivotable actuators 284, 286 and 288, respectively, are pivotable between open positions wherein stripped terminal ends 12a, 14a and 16a of first, second and third wires 12, 14, and 16, respectively, may be inserted into and removed from corresponding internal spring terminal connections through first, second and third passages 290, 292 and 294, respectively, in housing 282 and closed positions wherein stripped terminal ends 12a, 14a and 16a of first, second and third wires 12, 14, and 16, respectively, are clamped by spring force against a common conductive bus by closure of first, second and third pivotable actuators 284, 286 and 288, respectively, in cooperation with the internal spring terminal connections.

In operation, first, second and third wires 12, 14, and 16, respectively, are inserted sequentially through: opening 174 in first end 154 of sidewall 152 of plunger 22; upper wire passageway 160; aperture 262 in compression plate 260, lower wire passageway 214 and opening 209 in second end 208 of sidewall 204 such that first, second and third wires 12, 14, and 16, respectively, pass through plunger 22. Terminal ends 12a, 14a and 16a of first, second and third wires 12, 14, and 16, respectively, are stripped in any conventional matter.

Once first, second and third wires 12, 14, and 16, respectively, are routed through plunger 22 and terminal ends 12a, 14a and 16a of first, second and third wires 12, 14, and 16, respectively, are stripped to the appropriate length, first, second and third pivotable actuators 284, 286 and 288, respectively, of lever connector 280 are pivoted to their open positions, FIG. 3. Stripped terminal ends 12a, 14a and 16a of first, second and third wires 12, 14, and 16, respectively, are inserted into corresponding internal spring terminal connections within housing 282 through first, second and third passages 290, 292 and 294, respectively, in housing 282. First, second and third pivotable actuators 284, 286 and 288, respectively, of lever connector 280 are pivoted to their closed positions wherein stripped terminal ends 12a, 14a and 16a of first, second and third wires 12, 14, and 16, respectively, are clamped by spring force against a common conductive bus, thereby electrically coupling the first, second and third wires 12, 14, and 16, respectively, FIG. 4.

With first, second and third wires 12, 14, and 16, respectively, electrically coupled, lever connector 280 is urged toward second end 208 of sidewall 204 of plunger 22 such that portions 308a and 308b of upper wall 308 of housing 280 of lever connector 280 engage and form mating relationships with recesses 238 and 240, respectively, in terminal ends 234 and 236 of corresponding first and second side portions 218 and 220, respectively, of sidewall 204 of plunger 22. Plunger 22 and lever connector 280 combination, generally designated by the reference numeral 312, is now ready to be inserted into plunger cavity 20 in housing 18.

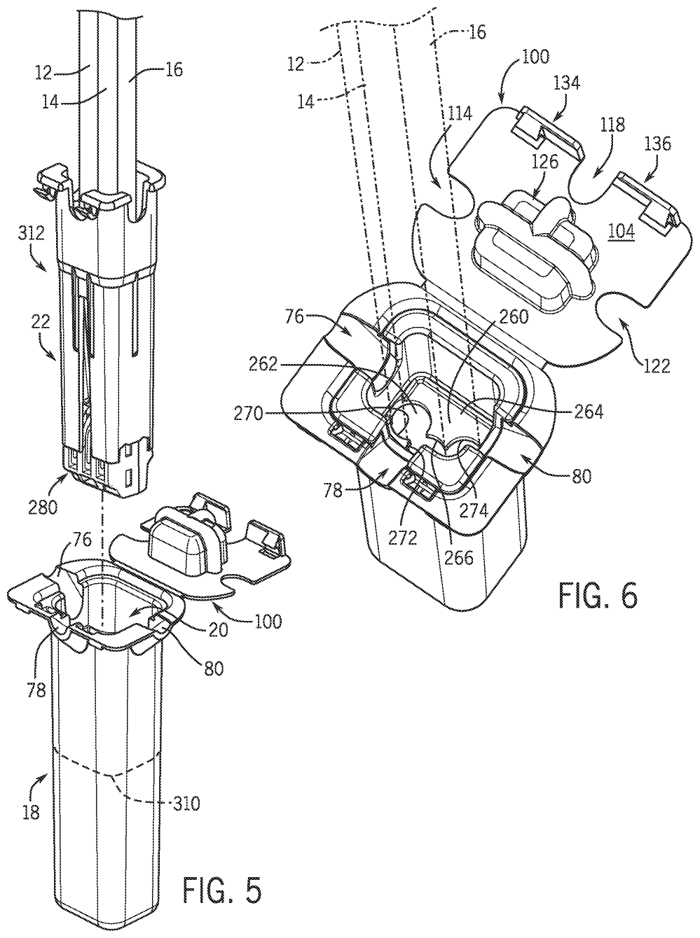

Plunger cavity 20 in housing 18 is partially filled with sealant 310, FIG. 5, of a sufficient amount to encompass and encapsulate lever connector 280 and terminal ends 12a, 14a and 16a of first, second and third wires 12, 14, and 16, respectively, FIGS. 7-8. With sealant 310 received in plunger cavity 20 in housing 18, plunger and lever connector combination 312 is inserted into plunger cavity 20 through opening 54 in first end 26 of sidewall 30. As plunger and lever connector combination 312 is inserted into plunger cavity 20, first and second side portions 218 and 220, respectively, of sidewall 204 of plunger 22 urges lever connector 280 into sealant 310. The spacing between outer surface 216 of sidewall 204 of plunger 22 and inner surface 32 of sidewall 30 of housing 18 allows for sealant 310 to filled volume of space therebetween. Further, slots 246 and 248 in first and second end portions 222 and 224, respectively, of sidewall 204 allow for sealant 310 to enter lower wire passageway 214 so as to surround lever connector 280. It is intended for intersection 210 to prevent sealant 310 from flowing into the inface between outer surface 164 of sidewall 152 of plunger 22 and inner surface 32 of sidewall 30 of housing 18.

Referring to FIGS. 1-2 and 7-8, as plunger 22 is urged further into plunger cavity 20 of housing 18, it can be appreciated that lower surface 261 of compression plate 260 engages sealant 310 in lower wire passageway 214 and urges sealant 310 to fill in all gaps and voids about lever connector 280 so as to isolate lever connector 280 and terminal ends 12a, 14a and 16a of first, second and third wires 12, 14, and 16, respectively, from the environment outside of sealant 310, and hence, outside of sealed connector 10. As plunger 22 is fully inserted into plunger cavity 22 of housing 18, first vertices 198 and then first and second legs 194 and 196, respectively of first and second v-shaped latches 190 and 192, respectively, are received and pass through corresponding apertures 91 and 93 provided on opposite sides of recess 78 in housing 18. As first and second legs 194 and 196, respectively of first and second v-shaped latches 190 and 192, respectively, pass through corresponding apertures 91 and 93, first and second legs 194 and 196, respectively, of each latch 190 and 192 are compressed toward each other, thereby allowing for terminal edges 200 of second legs 196 to pass through corresponding apertures 91 and 93.

Once terminal edges 200 of second legs 196 of latches 190 and 192 pass through corresponding apertures 91 and 93, second legs 196 of latches 190 and 192 are biased back to the original position such that the distance between first and second legs 194 and 196, respectively of first and second v-shaped latches 190 and 192, respectively, is sufficient to prevent first and second v-shaped latches 190 and 192, respectively, from passing back through corresponding apertures 91 and 93, thereby interconnecting plunger 22 to housing 18, FIG. 2. With plunger 22 interconnected to housing 18 as described, recesses 184, 186 and 188, respectively, in sidewall 152, of plunger 22 are aligned with corresponding recesses 76, 78 and 80 in housing 18 and flange 176 of plunger 22 is seated within shoulder 56 of housing 18 such that: 1) lower surface 182 of flange 176 forms a sealable interface with upper surface 62 of horizontal wall 58 to isolate so as to isolate the spacing between outer surface 216 of sidewall 204 of plunger 22 and inner surface 32 of sidewall 30 of housing 18 from the environment outside of sealed connector 10; 2) radially outer edge 178 of flange 176 is directed at vertical wall 64 of housing 18; and 3) upper surface 180 of flange 176 is substantially flush and lies in a generally common plane with upper surface 72 of flange 68 of housing 18.

Once plunger 22 is fully receiving in plunger cavity 20 and interconnected to housing 18, as heretofore described, first, second and third wires 12, 14, and 16, respectively, are positioned within corresponding first, second and third concave recesses 270, 272 and 274, respectively, of aperture 262 through connection plate 260 to facilitate the alignment of first, second and third wires 12, 14, and 16, respectively, with corresponding recesses 184, 186 and 188, respectively, in sidewall 152 of plunger 22. Thereafter, first wire 12 is routed through recess 184 in sidewall 152 of plunger 22 and recess 76 in housing 18; second wire 14 is routed through recess 186 in sidewall 152 of plunger 22 and recess 78 in housing 18; and third wire 16 is routed through recess 188 in sidewall 152 of plunger 22 and recess 80 in housing 18, FIG. 2. Lid 100 is then moved to the closed position, FIG. 1 to complete the assembly of sealed connector 10.

As lid 100 is moved to the closed position, tangs 138 and 140 of first and second flexible latches 134 and 136, respectively, engage radially outer edge 70 of flange 68 of housing 18 causing first and second flexible latches 134 and 136, respectively, to flex outwardly away from outer surface 36 of sidewall 30 of housing 18. Once tangs 138 and 140 of first and second flexible latches 134 and 136, respectively, pass radially outer edge 70 of flange 68 of housing 18, first and second flexible latches 134 and 136, respectively, are biased back to the original position such that tangs 138 and 140 of first and second flexible latches 134 and 136, respectively, are positioned against lower surface 74 of flange 68 and prevent lid 100 from returning to the open position.

With lid 100 in the closed position, inner surface 104 of lid 100 engages and forms a sealable interface with upper surface 72 of flange 68 of housing 18 to isolate upper and lower wire passageways 160 and 214 within plunger 22 from the environment outside of sealed connector 10. In addition, with lid 100 in the closed position, first recess 114 in first portion 116 of outer peripheral edge 108 of lid 100 extends partially about first wire 12 such that first wire 12 is surrounded by first recess 114 in lid 100 and recess 76 in housing 18; second recess 118 in second portion 120 of outer peripheral edge 108 extends partially about second wire 14 such that second wire 14 is surrounded by second 118 in lid 100 and recess 78 in housing 18; and third recess 122 in third portion 124 of outer peripheral edge 108 of lid 100 extends partially around third wire 16 such that third wire 16 is surrounded by recess 122 in lid 100 and recess 80 in housing 18. Further, with lid 100 in the closed position, first, second and third relief portions 128, 130 and 132, respectively, of strain relief dome 126 engage corresponding portions of first second and third wires 12, 14 and 16, respectively, within upper wire passageway 160 to minimize the strain on the connection between first, second and third wires 12, 14, and 16, respectively, and the common conductive bus, to prevent failure of the electrical connection therebetween.

Various modes of carrying out the invention are contemplated as being within the scope of the following claims particularly pointing out and distinctly claiming the subject matter, which is regarded as the invention.

We claim:

1. A sealed connector for electrically connecting a plurality of wires, comprising:
a tubular housing having a closed end, an open end, and an inner surface defining a plunger cavity adapted for receiving a sealant therein;
a plunger having first and second ends and a sidewall configured to allow the plurality of wires to be routed therepast, the plunger slidably receivable in the plunger cavity of the housing; and
a connector configured to electrically connect the plurality of wires, the connector positionable at the second end of the plunger;
wherein the plunger urges the connector toward the closed end of the housing as the plunger is inserted into the plunger cavity.

2. The sealed connector of claim 1 wherein:
the plunger is generally tubular and has first and second open ends;
the sidewall defines a passageway through the plunger for allowing the plurality of wires to pass therethrough; and
the sidewall includes a slot therethrough.

3. The sealed connector of claim 1 further comprising a compression plate extending from sidewall of the plunger, the compression plate including a lower surface configured to engage and urge the sealant in the plunger cavity toward the closed end of the housing as the plunger is inserted into the plunger cavity.

4. The sealed connector of claim 3 wherein the compression plate includes at least one aperture for allowing the plurality of wires to pass therethrough.

5. The sealed connector of claim 4 wherein:
the at least one aperture is defined by an inner edge of the compression plate;
the inner edge of the compression plate including a plurality of concave portions; and
each of the plurality of concave portions define a guide configured to guide a corresponding one of the plurality of wires through the aperture in the compression plate.

6. The sealed connector of claim 1 further comprising a lid positionable on the open end of the housing, the lid moveable from an open position allowing for the plunger to be inserted into and removed from the plunger cavity in the housing and a closed position wherein the lid at least partially isolates the plunger received in the plunger cavity from an environment external to the housing.

7. The sealed connector of claim 6 wherein at least one of the housing and the lid includes a recess formed therein, the recess allowing at least one of the plurality of wires to pass into the plunger cavity with the lid in the closed position.

8. The sealed connector of claim 7 wherein the lid includes an inner surface having a strain relief projection projecting therefrom, the strain relief projection engagable with at least one of the plurality of wires passing into the plunger cavity with the lid in the closed position.

9. The sealed connector of claim 1 wherein:
the housing further includes a shoulder projected from the inner surface of the housing adjacent the open end thereof; and
the sidewall of the plunger has an outer surface and the plunger includes a lip projecting from the outer surface of the plunger adjacent the first end thereof, the lip engageable with the shoulder of the housing with the plunger received in the plunger cavity of the housing.

10. The sealed connector of claim 1 wherein second end of the plunger is defined by a lower edge, the lower edge having a configuration adapted to form a mating relationship with the connector.

11. A sealed connector for electrically connecting a plurality of wires, comprising:
a housing having an inner surface defines a cavity adapted for receiving a sealant therein;
a plunger having first and second ends and a surface configured to allow the plurality of wires to pass therethrough, the plunger slidably receivable in the cavity of the housing; and
a connector configured to electrically connect the plurality of wires, the connector positionable at the second end of the plunger;
wherein the plunger urges the connector into the plunger cavity as the plunger is inserted into the plunger cavity.

12. The sealed connector of claim 11 wherein:
the plunger is generally tubular and includes a sidewall;
the sidewall includes a slot therethrough;
the first and second ends of the plunger are open; and
the surface of the plunger is an inner surface of the sidewall, the inner surface defining a passageway through the plunger for allowing the plurality of wires to pass therethrough.

13. The sealed connector of claim 11 wherein the cavity in the housing has a closed end and wherein the sealed connector further includes a compression plate extending from the surface of the plunger, the compression plate including a lower surface configured to engage and urge the sealant in the cavity toward the closed end of the housing as the plunger is inserted into the cavity.

14. The sealed connector of claim 13 wherein the compression plate includes at least one aperture for allowing the plurality of wires to pass therethrough.

15. The sealed connector of claim 14 wherein:
the at least one aperture is defined by an inner edge of the compression plate;
the inner edge of the compression plate including a plurality of concave portions; and
each of the plurality of concave portions define a guide configured to guide a corresponding one of the plurality of wires through the aperture in the compression plate.

16. The sealed connector of claim 11 further comprising a lid positionable on the housing, the lid moveable from an open position allowing for the plunger to be inserted into and removed from the cavity in the housing and a closed position.

17. The sealed connector of claim 16 wherein the lid includes an inner surface having a strain relief projection projecting therefrom, the strain relief projection engagable with at least one of the plurality of wires passing into the cavity with the lid in the closed position.

18. The sealed connector of claim 10 wherein the second end of the plunger is defined by a lower edge, the lower edge having a configuration adapted to form a mating relationship with the connector.

19. A method for electrically connecting terminal ends of a plurality of wires in a sealed environment, comprising:
depositing a sealant in a plunger cavity of a housing;
positioning the terminal ends of the plurality of wires at an end of a plunger;
electrically connecting the terminal ends of the plurality of wires; and
inserting the electrically connected terminal ends of the plurality of wires into the sealant in the plunger cavity in the housing with the plunger.

20. The method of claim 19 comprising the additional step of urging the sealant in the plunger cavity toward the electrically connected terminal ends of the plurality of wires such that sealant surrounds and environmentally isolates the electrically connected terminal ends of the plurality of wires from an environment outside the housing.

21. The method of claim 20 wherein the step of urging the sealant in the plunger cavity toward the electrically connected terminal ends of the plurality of wires includes the step of providing a compression plate which extends from a surface of the plunger, the compression plate including a lower surface configured to engage the sealant provided in the plunger cavity toward the electrically connected terminal ends of the plurality of wires as the plunger is inserted into the plunger cavity.

22. The method of claim 21 comprising the additional step of guiding the plurality of wires through the compression plate.

23. The method of claim 22 wherein:
the electrically connected terminal ends of the plurality of wires are guided by an inner edge of the compression plate;
the inner edge of the compression plate defining a plurality of concave portions;
each of the plurality of concave portions of the inner edge of the compression plate adapted for receiving a corresponding one of the plurality of wires therepast.

24. The method of claim 19 wherein the terminal ends of the plurality of wires are electrically connected by a connector.

25. The method of claim 24 wherein the plunger includes a lower edge, the lower edge of the plunger is adapted to form a mating relationship with the connector.
